(19) United States
(12) Patent Application Publication
(10) Pub. No.: US 2016/0107124 A1
(43) Pub. Date: Apr. 21, 2016

(54) FILTRATION DEVICE AND FILTRATION METHOD USING SAME

(71) Applicant: SUMITOMO ELECTRIC INDUSTRIES, LTD., Osaka-shi, Osaka (JP)

(72) Inventors: Hiromu TANAKA, Osaka (JP); Toru MORITA, Osaka (JP)

(73) Assignee: SUMITOMO ELECTRIC INDUSTRIES, LTD., Osaka-shi, Osaka (JP)

(21) Appl. No.: 14/893,700

(22) PCT Filed: Apr. 4, 2014
(86) PCT No.: PCT/JP2014/059948

§ 371 Date: Nov. 24, 2015

(30) Foreign Application Priority Data
May 30, 2013 (JP) 2013-114561

(51) Int. Cl. B01D 63/02; C02F 1/44; B01D 63/04; B01D 65/02

(52) U.S. Cl. CPC B01D 63/02; B01D 65/02; C02F 1/44; B01D 63/04; B01D 2321/18

(57) ABSTRACT

A filtration device includes a tubular body having an inlet and an outlet for a solution to be treated, and a plurality of hollow fiber membranes aligned in the tubular body. By creating a difference in pressure between the outside and inside of the hollow fiber membranes, water in the solution to be treated is passed from the outside to the inside. The filtration device further includes a gas supply unit configured to supply a bubble from below the plurality of hollow fiber membranes. The tubular body has a gas discharge port above the inlet and the outlet. The gas discharge port is provided for discharging the bubble supplied from the gas supply unit to the outside.

### TECHNICAL FIELD

The present invention relates to a filtration device and a filtration method using the same.

### BACKGROUND ART

As a solid-liquid separator for sewage treatment or the like, a filtration device having a filtration module formed by a bundle of hollow fiber membranes has been used. Examples of the filtration device having the filtration module include an external pressure type filtration device in which a solution to be treated is passed to the inner periphery sides of the hollow fiber membranes by raising the pressure on the outer periphery sides of the hollow fiber membranes, an immersion type filtration device in which a solution to be treated is passed to the inner periphery sides by osmotic pressure or negative pressure on the inner periphery sides, and an internal pressure type filtration device in which a solution to be treated is passed to the outer periphery sides of the hollow fiber membranes by raising the pressure on the inner periphery sides of the hollow fiber membranes.

Of the filtration devices described above, the external pressure type filtration device used is one that includes a tubular body having an inlet and an outlet for a solution to be treated, and a plurality of hollow fiber membranes aligned in the tubular body. In this filtration device, water in the solution to be treated is passed to the inside of the hollow fiber membranes by external pressure, and a filtrated solution is obtained by sucking up the passed water.

In the filtration device, the surface of each hollow fiber membrane is contaminated with use, for example, by adhesion of materials contained in the solution to be treated. This means that if nothing is done, the filtration performance is degraded. Therefore, the filtration device regularly performs a back washing operation which involves applying counter pressure to the hollow fiber membranes (see Japanese Unexamined Patent Application Publication No. 2010-36183). The back washing operation also involves supplying air into the tubular body to vibrate the hollow fiber membranes.

### CITATION LIST

### Patent Literature

PTL 1: Japanese Unexamined Patent Application Publication No. 2010-36183 Summary of Invention

### Technical Problem

The conventional external pressure type filtration device is not capable of appropriately preventing contamination on the surfaces of the hollow fiber membranes during filtration. Therefore, the back washing operation described above needs to be regularly performed. The filtration operation needs to be stopped for the back washing operation, which is performed by supplying a treated solution to the inside of the hollow fiber membranes. Therefore, if the back washing operation is frequently performed, the filtration efficiency is lowered.

On the basis of the circumstances described above, the present invention aims to provide a filtration device that includes hollow fiber membranes whose surfaces are less prone to contamination and can achieve high filtration efficiency, and also to provide a filtration method using the filtration device.

### Solution to Problem

A filtration device according to an aspect of the present invention for solving the problems described above includes a tubular body having an inlet and an outlet for a solution to be treated, and a plurality of hollow fiber membranes aligned in the tubular body. By creating a difference in pressure between the outside and inside of the hollow fiber membranes, water in the solution to be treated is passed from the outside to the inside. The filtration device further includes a gas supply unit configured to supply a bubble from below the plurality of hollow fiber membranes. The tubular body has a gas discharge port above the inlet and the outlet. The gas discharge port is provided for discharging the bubble supplied from the gas supply unit to the outside.

A filtration method according to another aspect of the present invention for solving the problems described above includes using the filtration device to filtrate a solution to be treated while causing a gas supply unit to supply a bubble.

### Advantageous Effects of Invention

The filtration device and filtration method described above can reduce adhesion of dirt to the surfaces of the hollow fiber membranes by supplying a bubble from the gas supply unit during filtration, and thus can achieve high filtration efficiency.

### BRIEF DESCRIPTION OF DRAWINGS

FIG. 1 is a schematic explanatory diagram of a filtration device according to an embodiment of the present invention.

FIG. 2 is a schematic explanatory diagram illustrating filtration in the filtration device according to the embodiment of the present invention.

FIG. 3a is a schematic bottom view of a lower holding member included in the filtration module of the filtration device illustrated in FIG. 1.

FIG. 3b is an end face view taken along line A-A in the lower holding member illustrated in FIG. 3a.

FIG. 4 is a schematic explanatory diagram of a filtration device according to an embodiment different from that illustrated in FIG. 1.

FIG. 5 is a schematic explanatory diagram of a filtration device according to an embodiment different from those illustrated in FIGS. 1 and 4.

FIG. 6 is a schematic bottom view of a lower holding member different in shape from the lower holding member illustrated in FIG. 3a.

FIG. 7 is a schematic cross-sectional view of a lower holding member different in shape from the lower holding member illustrated in FIG. 3b.

### DESCRIPTION OF EMBODIMENTS

### [Description of Embodiments of the Invention of the Present Application]

A filtration device according to an aspect of the present invention includes a tubular body having an inlet and an outlet for a solution to be treated, and a plurality of hollow fiber membranes aligned in the tubular body. By creating a difference in pressure between the outside and inside of the hollow fiber membranes, water in the solution to be treated is passed from the outside to the inside. The filtration device further includes a gas supply unit configured to supply a bubble from below the plurality of hollow fiber membranes. The tubular body has a gas discharge port above the inlet and the outlet. The gas discharge port is provided for discharging the bubble supplied from the gas supply unit to the outside.

The filtration device can reduce adhesion of dirt to the surfaces of the hollow fiber membranes by supplying a bubble from the gas supply unit while water in the solution to be treated is passed by creating a difference in pressure between the outside and inside of the hollow fiber membranes (i.e., during filtration). Therefore, the filtration device suffers little degradation in filtration performance caused by adhesion of dirt. Also, since bubbles supplied from the gas supply unit are discharged to the outside through the gas discharge port of the tubular body, the filtration device can suitably perform filtration.

The filtration device may be of an external pressure type. Thus, the filtration device can be configured by using a basic structure of an external pressure type filtration device that has been conventionally used.

The gas discharge port may be an opening at the top of the tubular body. Thus, bubbles supplied from the gas supply unit can be discharged to the outside from the opening at the top of the tubular body. Also, by using a hydraulic pressure produced by a difference in height between the opening and the hollow fibers, filtration can be performed with suitable pressure.

The tubular body may have an on-off valve for opening and closing the gas discharge port. Thus, by opening the on-off valve, bubbles supplied from the gas supply unit can be discharged to the outside from the gas discharge port. Also, by using the on-off valve, external pressure filtration can be performed with suitable pressure.

The filtration device may include a filtration module including the plurality of hollow fiber membranes and a plurality of lower holding portions configured to hold lower parts of the hollow fiber membranes, and the holding portions may be arranged at intervals. Thus, bubbles supplied from the gas supply unit pass through the spaces between the holding portions, and move up along the longitudinal direction of the hollow fiber membranes. The surfaces of the hollow fiber membranes can thus be cleaned appropriately.

The bubble supplied from the gas supply unit may be divided into a plurality of bubbles after colliding with the filtration module. The bubble supplied from the gas supply unit is thus divided by the filtration module into a plurality of bubbles, which move upward while being in contact with the surfaces of the hollow fiber membranes. These bubbles have a mean diameter close to the distance between adjacent ones of the hollow fiber membranes and are easily uniformly distributed among the hollow fiber membranes. Thus, with these bubbles, the surfaces of the hollow fiber membranes can be thoroughly cleaned. Since these bubbles are greater and move up faster than microbubbles, the surfaces of the hollow fiber membranes can be effectively cleaned with high abrasion pressure.

### [Details of Embodiments of the Invention of the Present Application]

A filtration device according to an embodiment of the present invention will now be described in detail with reference to the drawings.

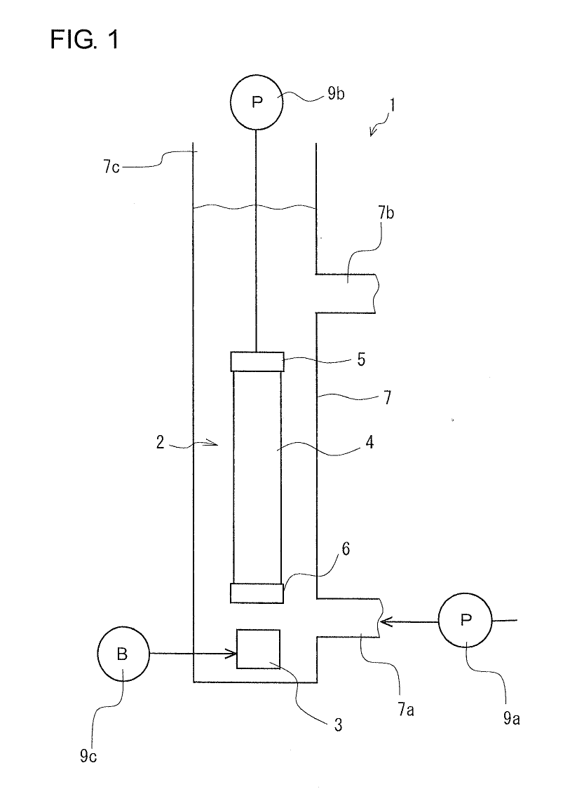

A filtration device 1 illustrated in FIG. 1 includes a tubular body 7 and a filtration module 2. In other words, the filtration device 1 includes the filtration module 2, and the tubular body 7 containing the filtration module 2 in its internal space and having an inlet 7a and an outlet 7b for a solution to be treated. The inlet 7a and the outlet 7b allow the internal space of the tubular body 7 to communicate with the outside. An external pressure type filtration device can be used as the filtration device 1. The external pressure type filtration device is not particularly limited, but is, for example, a filtration device of an external pressure cycle filtration type (external pressure cross-flow type) that circulates and discharges untreated water, such as oil-bearing wastewater.

The filtration device 1 further includes a gas supply unit 3 that supplies bubbles from below the filtration module 2. The gas supply unit 3 has a gas supply pump 9c for supplying bubbles. The filtration device 1 further includes a supply pump 9a for supplying a solution to be treated into the tubular body 7, and a suction pump 9b for collecting a treated solution from the filtration module 2. The supply pump 9a increases the pressure in the tubular body 7 and outside the hollow fiber membranes 4 to a high level, whereas the suction pump 9b reduces the pressure inside the hollow fiber membranes 4 to a low level.

<Tubular Body>

As described above, the tubular body 7 has the inlet 7a and the outlet 7b for a solution to be treated. The inlet 7a is disposed below the outlet 7b. The shape of the tubular body 7 is not particularly limited, but the tubular body 7 is, for example, in the shape of a cylinder with a bottom and has the inlet 7a and the outlet 7b in the side wall thereof. The tubular body 7 is circular in cross section, and has a circular cylindrical shape. The tubular body 7 is placed such that its longitudinal direction (axial direction) is along the vertical direction.

The size of the tubular body 7 is not particularly limited, but the length of the tubular body 7 ranges, for example, from 1 m to 7 m. The inside diameter of the tubular body 7 ranges, for example, from 10 cm to 40 cm.

The tubular body 7 has a gas discharge port 7c above the outlet 7b and the inlet 7a. Bubbles supplied from the gas supply unit 3 are discharged from the gas discharge port 7c to the outside. The gas discharge port 7c is formed by an opening at the top of the tubular body 7.

The vertical distance between the gas discharge port 7c and the outlet 7b is not limited, as long as a sufficient hydraulic pressure can be obtained in and around the filtration module 2. However, the minimum value of the vertical distance is preferably 0.5 m, more preferably 1 m, and still more preferably 2 m. If the vertical distance is less than the minimum value, a sufficient hydraulic pressure may not be obtained in and around the filtration module 2. The maximum value of the vertical distance is not particularly limited, but is, for example, 5 m.

The material of the tubular body 7 is not particularly limited, but a material with good chemical resistance can be suitably used. Specifically, the tubular body 7 can be formed of a metal material, such as stainless steel, or of an engineering plastic, such as ABS resin, PVC, PTFE, PSF, Celite, or PEEK.

The supply pump 9a supplies water to be treated such that the hydraulic pressure in the tubular body 7 is a predetermined value. The minimum value of the hydraulic pressure (i.e., hydraulic pressure at an upper end of the filtration module 2 (or at an upper holding member 5 described below)) is preferably 20 kPa, and more preferably 10 kPa. If the hydraulic pressure is less than the minimum value, the filtration performance of the filtration device 1 may be degraded. The maximum value of the hydraulic pressure is preferably 60 kPa, and more preferably 50 kPa. If the hydraulic pressure exceeds the maximum value, the cost of the entire device may be increased to ensure the mechanical strength of the tubular body 7 and the like. Additionally, the entire device may be oversized because it is necessary to raise the position of the gas discharge port 7c.

<Filtration Module>

The filtration module 2 includes the hollow fiber membranes 4 vertically pulled into alignment, and the upper holding member 5 and a lower holding member 6 for vertical positioning of the hollow fiber membranes 4. When a bubble supplied from the gas supply unit 3 collides with the filtration module 2 (or its lower holding member 6), the bubble is divided into a plurality of bubbles by the filtration module 2 (or its lower holding member 6).

(Upper Holding Member and Lower Holding Member)

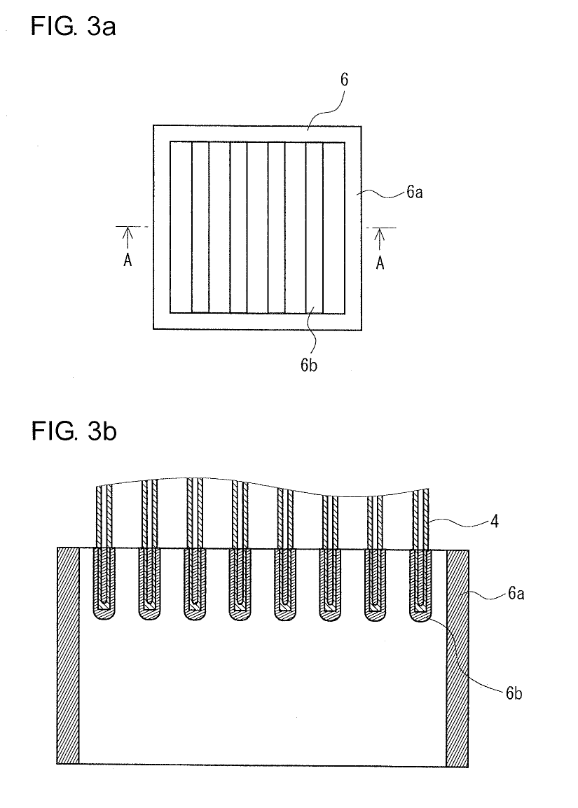

The lower holding member 6 has a plurality of lower securing portions 6b (holding portions) that hold the lower parts of the hollow fiber membranes 4. Specifically, as illustrated in FIG. 3a, the lower holding member 6 has an outer frame 6a and the securing portions 6b that secure the lower end portions of the hollow fiber membranes 4. The securing portions 6b have, for example, a bar-like shape, and are arranged at regular intervals in parallel or substantially parallel with each other. The hollow fiber membranes 4 are disposed on the upper sides of the respective securing portions 6b. Since the securing portions 6b are thus arranged at regular intervals in parallel or substantially parallel with each other, a bubble can be evenly divided as described below.

The outer frame 6a is a component for supporting the securing portions 6b. The length of one side of the outer frame 6a is not particularly limited, but, for example, ranges from 5 cm to 20 cm. The cross-sectional shape of the outer frame 6a is not particularly limited, and may be a rectangular shape as illustrated in FIG. 3a or another polygonal shape or a circular shape.

The upper holding member 5 is a component that holds the upper end portions of the hollow fiber membranes 4. The upper holding member 5 has suction ports that communicate with the upper openings of the hollow fiber membranes 4 to collect a filtrated solution. The suction pump 9b is connected to the suction ports through a suction tube so as to suck up the filtrated solution penetrating inside the hollow fiber membranes 4. The outer shape of the upper holding member 5 is not particularly limited, and the cross-sectional shape of the upper holding member 5 can be polygonal or circular.

Each of the hollow fiber membranes 4 may be secured at its both ends by the upper holding member 5 and the lower holding member 6. Alternatively, each of the hollow fiber membranes 4 may be bent into a U-shape. In this case, two opening portions of the hollow fiber membrane 4 are secured by the upper holding member 5, and the folded (bent) portion at the lower end of the hollow fiber membrane 4 is secured by the lower holding member 6.

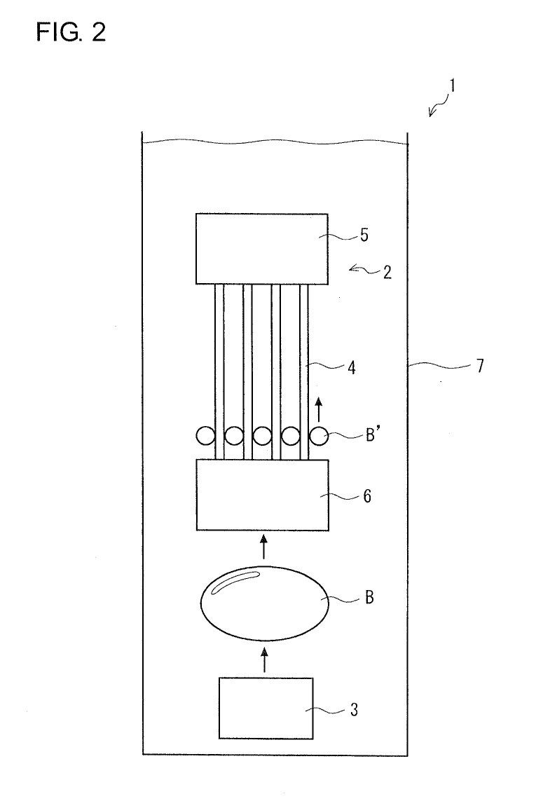

A bubble B supplied from the gas supply unit 3 (described below) is divided into a plurality of bubbles B′ by a collision with the securing portions 6b. The bubbles B′ pass through spaces between the securing portions 6b to move upward while abrading the surfaces of the hollow fiber membranes 4. As illustrated in FIG. 2, the positions of the securing portions 6b in the vertical direction are aligned.

The width (or length in the lateral direction) of the securing portions 6b and the distance between adjacent ones of the securing portions 6b are not particularly limited, as long as a sufficient number of hollow fiber membranes 4 can be secured and a bubble supplied from the gas supply unit 3 can be divided into a plurality of bubbles. For example, the width of the securing portions 6b can range from 3 mm to 10 mm, and the distance between adjacent ones of the securing portions 6b can range from 1 mm to 10 mm.

The maximum value of the density of distribution of the hollow fiber membranes 4 (N/A), obtained by dividing the number N of the hollow fiber membranes 4 held by the lower holding member 6 by the area A of the region where the hollow fiber membranes 4 are arranged, is preferably 15 per square centimeter (cm²) and more preferably 12 per square centimeter. If the density of distribution of the hollow fiber membranes 4 exceeds the maximum value, the surfaces of the hollow fiber membranes 4 may not be sufficiently cleaned due to small distances between the hollow fiber membranes 4. The minimum value of the density of distribution of the hollow fiber membranes 4 is preferably 4 per square centimeter and more preferably 6 per square centimeter. If the density of distribution of the hollow fiber membranes 4 is less than the minimum value, the filtration efficiency of the filtration device 1 per unit volume may be lowered. Note that the “region where the hollow fiber membranes are arranged” refers to a virtual polygonal region having the smallest area among those containing all the hollow fiber membranes included in the filtration module, as viewed in the axial direction.

The maximum value of the area ratio of the hollow fiber membranes 4 (S/A), obtained by dividing the total sum S of the cross-sectional areas of the hollow fiber membranes 4 held by the lower holding member 6 (on the basis of the assumption that the hollow fiber membranes 4 are solid) by the area A of the region where the hollow fiber membranes 4 are arranged, is preferably 60% and more preferably 55%. If the area ratio of the hollow fiber membranes 4 exceeds the maximum value, the surfaces of the hollow fiber membranes 4 may not be thoroughly cleaned due to small distances between the hollow fiber membranes 4. The minimum value of the area ratio of the hollow fiber membranes 4 is preferably 20% and more preferably 25%. If the area ratio of the hollow fiber membranes 4 is less than the minimum value, the filtration efficiency of the filtration device 1 per unit volume may be lowered.

The material of the upper holding member 5 and the lower holding member 6 is not particularly limited, and, for example, epoxy resin, ABS resin, or silicone resin can be used.

The method for securing the hollow fiber membranes 4 to the upper holding member 5 and the lower holding member 6 is not particularly limited. For example, a securing method using an adhesive can be used.

The upper holding member 5 and the lower holding member 6 are secured in the tubular body 7. For ease of handling (transportation, installation, replacement, etc.) of the filtration module 2, the upper holding member 5 and the lower holding member 6 are preferably coupled to each other by a coupling member. For example, metal support rods or a resin outer casing can be used as the coupling member.

The upper holding member 5 is secured within the tubular body 7 at a location below the outlet 7b. Thus, a solution to be treated can be filtrated under sufficient hydraulic pressure by the hollow fiber membranes 4. The vertical distance between the upper holding member 5 and the gas discharge port 7c is not limited, as long as sufficient hydraulic pressure can be obtained in the filtration module 2, but the minimum value of the vertical distance is preferably 0.5 m, more preferably 1 m, and still more preferably 2 m. If the vertical distance is less than the minimum value, a sufficient hydraulic pressure may not be obtained in and around the filtration module 2. The maximum value of the vertical distance is not particularly limited, but is, for example, 5 m.

(Hollow Fiber Membrane)

The hollow fiber membranes 4 are porous membranes that allow water to pass through their inner hollow portions, and block passage of particles contained in a solution to be treated. Specifically, by making the pressure inside the tubular body 7 and outside the hollow fiber membranes 4 different from the pressure inside the hollow fiber membranes 4, water in the solution to be treated is passed from the outside to the inside of the hollow fiber membranes 4.

A thermoplastic resin can be used as the main component to form the hollow fiber membranes 4. Examples of the thermoplastic resin include polyethylene, polypropylene, polyvinylidene fluoride, ethylene-vinyl alcohol copolymer, polyamide, polyimide, polyetherimide, polystyrene, polysulfone, polyvinyl alcohol, polyphenylene ether, polyphenylene sulfide, cellulose acetate, polyacrylonitrile, and polytetrafluoroethylene (PTFE). In particular, PTFE which is a porous resin having high chemical resistance, heat resistance, weather resistance, and incombustibility is preferable, and a uniaxially or biaxially oriented PTFE is more preferable. Materials for forming the hollow fiber membranes 4 may appropriately include another type of polymer and an additive such as a lubricant.

The hollow fiber membranes 4 preferably have a multilayer structure to achieve both water permeability and mechanical strength, and also to enhance the surface cleaning effect of bubbles. Specifically, the hollow fiber membranes 4 each preferably have an inner support layer and a filtration layer on the surface of the support layer.

For example, a tube formed by extrusion molding of a thermoplastic resin can be used as the support layer. By using a tube formed by extrusion molding as the support layer, the support layer can have mechanical strength and facilitate formation of pores therein. The tube is preferably stretched at a stretch ratio ranging from 50% to 700% in the axial direction, and at a stretch ratio ranging from 5% to 100% in the circumferential direction.

The temperature at which the stretching is carried out is preferably lower than or equal to the melting point of the tube material. For example, the temperature preferably ranges from about 0° C. to about 300° C. To obtain a porous body having pores with a relatively large diameter, the stretching is preferably carried out at a low temperature, whereas to obtain a porous body having pores with a relatively small diameter, the stretching is preferably carried out at a high temperature. By heat-treating the stretched porous body at a temperature of 200° C. to 300° C. for about 1 to 30 minutes, with both ends thereof secured in a stretched state, high dimensional stability can be achieved. The size of pores in the porous body can be regulated by combination of conditions, such as the stretch temperature and the stretch ratio.

When PTFE is used to form the support layer, a tube that forms the support layer can be obtained, for example, by blending a liquid lubricant, such as naphtha, with PTFE fine powder, forming the resulting material into a tubular shape by extrusion molding or the like, and stretching it. By sintering the tube by holding it for several tens of seconds to several minutes in a heating furnace in which the temperature is kept at the melting point of PTFE fine powder or higher, such as about 350° C. to about 550° C., the dimensional stability can be improved.

The minimum value of the number average molecular weight of the PTFE fine powder is preferably half a million and more preferably two millions. If the number average molecular weight of the PTFE fine powder is less than the minimum value, bubble abrasion may damage the surfaces of the hollow fiber membranes 4 or may degrade the mechanical strength. The maximum value of the number average molecular weight of the PTFE fine powder is preferably 20 millions. If the number average molecular weight of the PTFE fine powder exceeds the maximum value, it may be difficult to form pores in the hollow fiber membranes 4. Note that the number average molecular weight is a value measured by gel filtration chromatography.

The filtration layer can be formed, for example, by wrapping a thermoplastic resin sheet around the support layer and sintering it. Using a sheet to form the filtration layer can facilitate stretching, make it easy to regulate the shape and size of pores, and reduce the thickness of the filtration layer. Wrapping and sintering of the sheet integrates the support layer and the filtration layer together, allows pores in both the layers to communicate with each other, and thus improves water permeability. The sintering temperature is preferably equal to or higher than the melting point of the tube forming the support layer and is preferably equal to or higher than the melting point of the sheet forming the filtration layer.

The sheet forming the filtration layer can be obtained, for example, by (1) a method in which a green compact obtained by extrusion of resin is stretched at a temperature lower than or equal to the melting point and then sintered, or (2) a method in which a sintered resin compact is slowly cooled to enhance crystallinity, and then is stretched. The sheet is preferably stretched at a stretch ratio ranging from 50% to 1000% in the longitudinal direction and at a stretch ratio ranging from 50% to 2500% in the lateral direction. Particularly when the stretch ratio for the lateral direction has the above-described range, it is possible to improve the mechanical strength in the circumferential direction by wrapping the sheet, and also to improve resistance to surface cleaning with large-volume bubbles.

When the filtration layer is formed by wrapping the sheet around the tube forming the support layer, fine irregularities may be formed on the outer periphery of the tube. By forming the fine irregularities on the outer periphery of the tube, it is possible to prevent positional displacement from the sheet, improve adhesion between the tube and the sheet, and prevent the filtration layer from being peeled off the support layer by cleaning with bubbles. The number of turns of the sheet can be one or more, and can be regulated by the thickness of the sheet. A plurality of sheets may be wrapped around the tube. The method of wrapping the sheet is not particularly limited. The sheet may be wrapped in the circumferential direction of the tube or in a spiral manner.

The difference in height between higher and lower points in the fine irregularities preferably ranges from 20 μm to 200 μm. The fine irregularities are preferably given to the entire outer periphery of the tube, but may be given partly or intermittently. Examples of the method for giving the fine irregularities to the outer periphery of the tube include surface treatment with flame, laser irradiation, plasma irradiation, and dispersive application of fluorocarbon resin. The surface treatment with flame is preferable because the irregularities can be easily formed without affecting the properties of the tube.

An unfired tube and an unfired sheet may be sintered after the sheet is wrapped around the tube, so as to improve adhesion between the tube and the sheet.

The diameter and thickness of the support layer and the filtration layer are not particularly limited. The maximum value of the mean outside diameter of the support layers (i.e., mean outside diameter of the hollow fiber membranes 4) is preferably 7 mm and more preferably 5 mm. If the mean outside diameter exceeds the maximum value, the filtration efficiency may be lowered, due to the small ratio of the surface area to the cross-sectional area of the hollow fiber membranes 4. The minimum value of the mean outside diameter of the support layers is preferably greater than or equal to 0.5 mm and more preferably 1 mm. If the mean outside diameter is less than the minimum value, the mechanical strength of the hollow fiber membranes 4 may be insufficient.

The maximum value of the mean inside diameter of the filtration layers (i.e., mean inside diameter of the hollow fiber membranes 4) is preferably 5 mm and more preferably 4 mm. If the mean inside diameter exceeds the maximum value, the mechanical strength and the effect of blocking the passage of impurities may be insufficient due to the small thickness of the hollow fiber membranes 4. The minimum value of the mean inside diameter of the filtration layers is preferably 0.25 mm and more preferably 0.5 mm. If the mean inside diameter is less than the minimum value, the pressure loss in sucking the filtrated solution in the hollow fiber membranes 4 may be increased.

The maximum value of the ratio of the mean inside diameter to the mean outside diameter of the hollow fiber membranes 4 is preferably 0.8 and more preferably 0.7. If the ratio of the mean inside diameter to the mean outside diameter of the hollow fiber membranes 4 exceeds the maximum value, the mechanical strength, the effect of blocking the passage of impurities, and the resistance to surface cleaning with large-volume bubbles may be insufficient due to the small thickness of the hollow fiber membranes 4. The minimum value of the ratio of the mean inside diameter to the mean outside diameter of the hollow fiber membranes 4 is preferably 0.3 and more preferably 0.5. If the ratio of the mean inside diameter to the mean outside diameter of the hollow fiber membranes 4 is less than the minimum value, the water permeability of the hollow fiber membranes 4 may be lowered because the hollow fiber membranes 4 are thicker than necessary.

The maximum value of the mean thickness of the filtration layers is preferably 200 and more preferably 100 μm. The minimum value of the mean thickness of the filtration layers is preferably 3 μm and more preferably 5 When the mean thickness of the filtration layers is within the range described above, the hollow fiber membranes 4 can easily and reliably achieve high filtration performance.

The minimum value of the mean thickness of the support layers is preferably 0.25 mm and more preferably 0.5 mm. The maximum value of the mean thickness of the support layers is preferably 2 mm and more preferably 1 mm. When the mean thickness of the support layers is within the range described above, the hollow fiber membranes 4 can achieve both mechanical strength and water permeability in a balanced manner.

The mean length of the hollow fiber membranes 4 is not particularly limited, and can range, for example, from 1 m to 3 m. The mean length of the hollow fiber membranes 4 refers to the mean distance between the upper end portions secured by the upper holding member 5 and the lower end portions secured by the lower holding member 6. When each of the hollow fiber membranes 4 is bent into a U-shape (as described below) and the bent portion is secured as the lower end portion by the lower holding member 6, the mean length of the hollow fiber membranes 4 refers to the mean distance from such lower end portions to the upper end portions (opening portions).

The maximum value of the porosity of each hollow fiber membrane 4 is preferably 90% and more preferably 85%. If the porosity of the hollow fiber membrane 4 exceeds the maximum value, the mechanical strength of the hollow fiber membrane 4 and its resistance to abrasion may be insufficient. The minimum value of the porosity of each hollow fiber membrane 4 is preferably 75% and more preferably 78%. If the porosity of the hollow fiber membrane 4 is less than the minimum value, the water permeability of the hollow fiber membrane 4 and the filtration performance of the filtration device 1 may be lowered. The porosity refers to the ratio of the total volume of pores to the volume of the hollow fiber membrane 4, and can be determined by measuring the density of the hollow fiber membrane 4 in accordance with ASTM-D-792.

The maximum value of the areal percentage of pores in each hollow fiber membrane 4 is preferably 60%. If the areal percentage of the pores exceeds the maximum value, the surface strength of the hollow fiber membrane 4 may be insufficient and the hollow fiber membrane 4 may be damaged by bubble abrasion. The minimum value of the areal percentage of pores in each hollow fiber membrane 4 is preferably 40%. If the areal percentage of the pores is less than the minimum value, the water permeability of the hollow fiber membrane 4 and the filtration performance of the filtration device 1 may be lowered. The areal percentage of pores refers to the ratio of the total area of pores in the outer periphery (filtration layer surface) of the hollow fiber membrane 4 to the surface area of the hollow fiber membrane 4, and can be determined by analyzing the electron micrograph of the outer periphery of the hollow fiber membrane 4.

The maximum value of the mean diameter of pores in each hollow fiber membrane 4 is preferably 0.45 μm and more preferably 0.1 p.m. If the mean diameter of pores in the hollow fiber membrane 4 exceeds the maximum value, impurities contained in the solution to be treated may not be blocked from passing into the hollow fiber membrane 4. The minimum value of the mean diameter of pores in each hollow fiber membrane 4 is preferably 0.01 If the mean diameter of pores in each hollow fiber membrane 4 is less than the minimum value, the water permeability may be lowered. The mean diameter of pores refers to the mean diameter of pores in the outer periphery (filtration layer surface) of the hollow fiber membrane 4, and can be measured by a pore size distribution measuring device (e.g., automated pore size distribution measuring system for porous materials, manufactured by Porus Materials, Inc.).

The minimum value of the tensile strength of the hollow fiber membranes 4 is preferably 50 N and more preferably 60 N. If the tensile strength of the hollow fiber membranes 4 is less than the minimum value, the resistance to surface cleaning with large-volume bubbles may be lowered. The maximum value of the tensile strength of the hollow fiber membranes 4 is generally 150 N. The tensile strength refers to a maximum tensile stress obtained in a tensile test performed in accordance with JIS-K7161: 1994 at a gauge distance of 100 mm and a testing speed of 100 mm/minute.

<Gas Supply Unit>

From below the filtration module 2, the gas supply unit 3 supplies the bubble B for cleaning the surfaces of the hollow fiber membranes 4. As described above, the bubble B is divided by the securing portions 6b into the bubbles B′, which abrade the surfaces of the hollow fiber membranes 4 for cleaning. The gas supply unit 3 has a single bubble discharge port. That is, the single filtration device 1 has, in the single filtration module 2, a bubble discharge port corresponding to that of the gas supply unit 3.

A publicly known gas supply unit can be used as the gas supply unit 3. For example, the gas supply unit 3 may be one that is immersed together with the filtration module 2 in a solution to be treated, retains gas continuously supplied from a compressor through an air supply pipe (not shown), and supplies the bubble B by intermittently discharging a certain volume of gas retained therein.

The mean horizontal diameter of the bubble supplied from the gas supply unit 3 is greater than the largest distance between adjacent secured portions of the hollow fiber membranes 4 (i.e., portions secured to the securing portions 6b). The minimum value of the mean horizontal diameter of the bubble supplied from the gas supply unit 3 is preferably twice the largest distance between adjacent secured portions of the hollow fiber membranes 4 in the filtration module 2, more preferably three times the largest distance, and still more preferably four times the largest distance. If the mean horizontal diameter of the bubble supplied from the gas supply unit 3 is less than the minimum value, the number and size of bubbles formed by the securing portions 6b may be insufficient, and the surfaces of the hollow fiber membranes 4 may not be sufficiently cleaned with the bubbles. The “mean horizontal diameter of the bubble” refers to the mean value of the minimum width of the bubble in the horizontal direction, measured immediately before the bubble collides with the hollow fiber membranes or the holding portions after being discharged from the gas supply unit 3. The “largest distance between adjacent holding portions of the hollow fiber membranes” refers to the largest distance of all the distances between adjacent holding portions for holding the hollow fiber membranes.

Bubbles supplied from the gas supply unit 3 are not particularly limited, as long as they are inert. From the perspective of operating cost, it is preferable that air bubbles be used.

<Usage and Advantages>

The filtration device 1 can perform external pressure filtration by supplying a solution to be filtrated into the tubular body 7 while applying pressure thereto. Specific applications of the filtration device 1 include purification of groundwater and river surface water, general industrial drainage treatment, and insoluble oil-bearing wastewater treatment. The filtration device 1 described above is suitable for use in treatment of a solution with lower turbidity, as compared to the filtration device 1 of an immersion type and the filtration device 1 of an internal pressure type. Also, the filtration device 1 described above is suitable for use in high-volume treatment, as compared to the filtration device 1 of an internal pressure type.

The filtration method using the filtration device 1 involves supplying a solution to be treated into the tubular body 7 while applying pressure thereto and, at the same time, supplying bubbles from the gas supply unit 3. With the bubbles, it is possible to prevent dirt from adhering to the surfaces of the hollow fiber membranes 4, remove dirt adhering to the surfaces of the hollow fiber membranes 4, and thus reduce adhesion of dirt to the surfaces of the hollow fiber membranes 4. Therefore, the filtration device 1 suffers little degradation in filtration performance caused by adhesion of dirt. Additionally, since the outlet 7b is located above the inlet 7a, an upward stream of water is produced in the tubular body 7 during filtration. Since the bubbles rise along this stream of water, the high-speed upward stream of bubbles can effectively clean the surfaces of the hollow fiber membranes 4 with high abrasion pressure.

Since the mean horizontal diameter of the bubble B supplied from the gas supply unit 3 is greater than the largest distance between adjacent secured portions of the hollow fiber membranes 4, the bubble B is divided by the securing portions 6b into the bubbles B′, which move upward while being in contact with the surfaces of the hollow fiber membranes 4. The bubbles B′ have a mean diameter close to the distance between adjacent ones of the hollow fiber membranes 4 and are easily uniformly distributed among the hollow fiber membranes 4. Thus, the surfaces of the hollow fiber membranes 4 can be thoroughly cleaned with the bubbles B′. Since the bubbles B′ move up faster than conventional microbubbles, the surfaces of the hollow fiber membranes 4 can be effectively cleaned with high abrasion pressure. In the filtration device 1, the bubbles B′ move up along the longitudinal direction of each hollow fiber membrane 4. Therefore, the surfaces of the hollow fiber membranes 4 can be cleaned efficiently and effectively.

The filtration device 1 includes the gas supply unit 3 that retains bubbles to be continuously supplied. The gas supply unit 3 intermittently discharges the retained bubbles to supply them. It is thus possible to easily and reliably supply large-volume bubbles to the filtration module 2 at low cost.

Bubbles supplied from the gas supply unit 3 are discharged to the outside through the gas discharge port 7c of the tubular body 7. Thus, by suitably maintaining the hydraulic pressure in and around the filtration module 2, suitable external pressure filtration can be performed.

### Other Embodiments

Embodiments described herein are to be considered illustrative, not restrictive, in all aspects. The scope of the present invention is not limited to the configuration of the embodiment described above, but is defined by the claims and is intended to include all modifications within the meanings and scope equivalent to the claims.

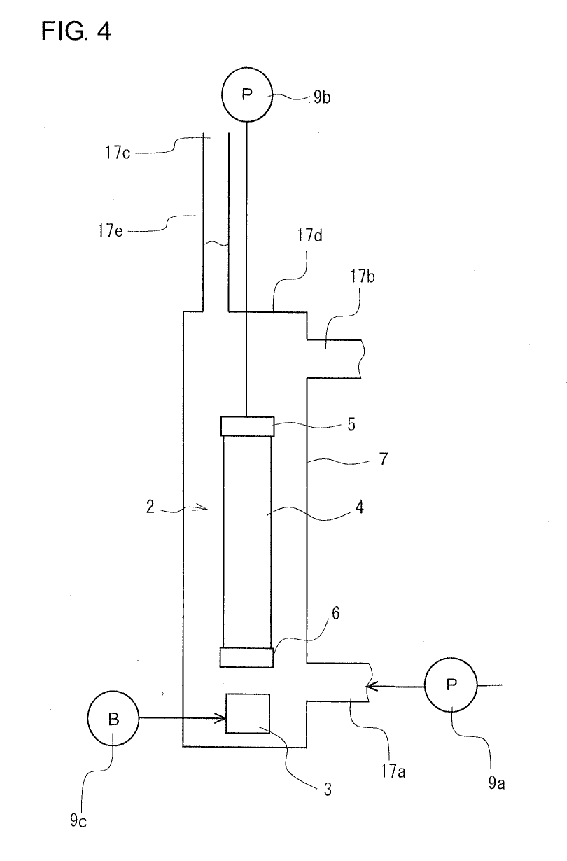

Although the tubular body 3 is in the shape of an open-top cylinder with a bottom in the embodiment described above, the scope of the present invention is not limited to this. As illustrated in FIG. 4, the tubular body 7 having a top surface portion 17d and an exhaust pipe 17e can be used. The top surface portion 17d closes the upper part of the tubular body 7. The exhaust pipe 17e forms a gas discharge port 17c at one end (upper end) thereof, passes through the top surface portion 17d (or the peripheral wall of the tubular body 17), and is disposed inside the tubular body 17 at the other end (lower end) thereof. In FIG. 4, reference numeral 17a denotes an inlet, reference numeral 17b denotes an outlet, and other reference numerals denote the same components as those of the embodiment illustrated in FIG. 1. The position of the gas discharge port 17c in the vertical direction (e.g., the distance between the outlet 17b and the gas discharge port 17c) will not be described here, as it has the same range as the preferred range described in the foregoing embodiment.

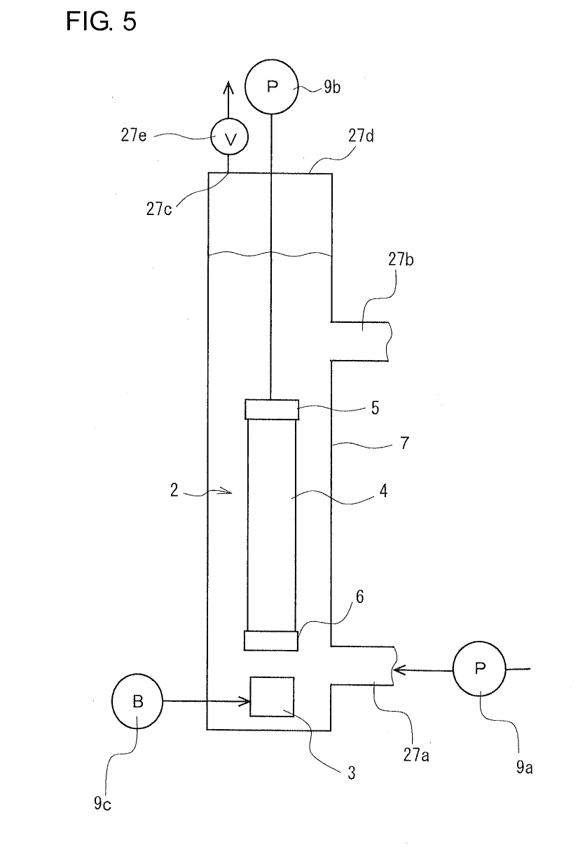

Although the gas discharge port is an opening at the top of the tubular body in the embodiment described above, the scope of the present invention is not limited to this. For example, the gas discharge port may be configured to be opened and closed by an on-off valve. Specifically, as illustrated in FIG. 5, the tubular body 7 may be configured to have an on-off valve 27e for opening and closing a gas discharge port 27c. Examples of the on-off valve include a valve for regularly opening and closing the gas discharge port, and a valve for opening and closing the gas discharge port with predetermined pressure or more. Such an on-off valve may be attached to the exhaust pipe 17e illustrated in FIG. 4. In FIG. 5, reference numeral 27a denotes an inlet, reference numeral 27b denotes an outlet, reference numeral 27d denotes a top surface portion, and other reference numerals denote the same components as those of the embodiment illustrated in FIG. 1.

The filtration device may include a plurality of filtration modules. When the filtration device includes a plurality of filtration modules, a plurality of gas supply units corresponding to the respective filtration modules may be provided, or a gas supply unit having a plurality of bubble discharge ports for supplying bubbles to the plurality of filtration modules may be provided.

Although the gas supply unit 3 that intermittently supplies bubbles to the filtration module 2 has been described in the foregoing embodiment, the scope of the present invention is not limited to this, and the gas supply unit 3 that continuously supplies bubbles may be used. Although the gas supply unit 3 disposed directly below the filtration module 2 has been described, the scope of the present invention is not limited to this, and any gas supply unit capable of supplying bubbles to the filtration module from below can be used. Specifically, for example, gas supply pipes may be provided between the hollow fiber membranes so that the gas supply unit can be formed by the gas supply pipes.

In the embodiment described above, the lower holding member 6 has the bar-like securing portions 6b that hold the hollow fiber membranes 4. However, the scope of the present invention is not limited to this. That is, for example, a plurality of securing portions (holding portions) holding the respective hollow fiber membranes 4 may be arranged at intervals.

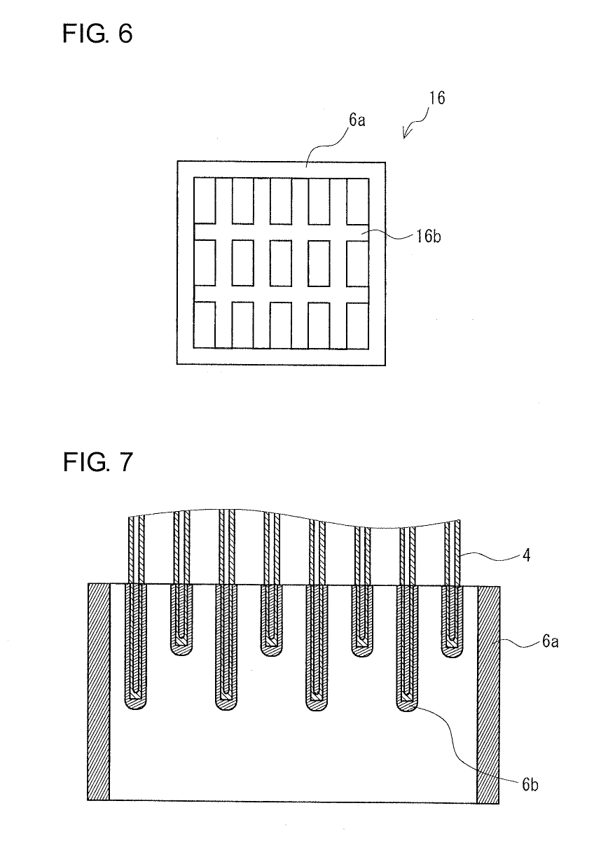

Although the lower holding portions are arranged at intervals in the embodiment described above, the scope of the present invention is not limited to this. Even when the lower holding portions are arranged at intervals as in the embodiment described above, the configuration is not limited to that of the embodiment. That is, for example, as in a lower holding member 16 illustrated in FIG. 6, a plurality of through holes may be formed in a plate-like securing portion 16b to obtain securing portions 16b arranged at intervals.

As illustrated in FIG. 7, adjacent securing portions 6b may be disposed at different levels in the vertical direction. Thus, by disposing adjacent securing portions 6b at different levels, it is possible to improve the shear force of the securing portions against a bubble and to more uniformly divide the bubble into a plurality of bubbles.

The gas supply unit used in the filtration device is not limited to that of the embodiment described above. When the gas supply unit intermittently supplies bubbles as in the embodiment described above, it is preferable that the bubbles each have a volume sufficient for being divided by the securing portions into a plurality of bubbles. In this case, a bubble generator (air diffuser) other than that described in the embodiment may be used.

The direction in which the hollow fiber membranes of the filtration module are pulled into alignment is not limited to the vertical direction, and may be the horizontal or diagonal direction. Even when the hollow fiber membranes are pulled in such a direction into alignment, a bubble supplied from below is divided between the hollow fiber membranes, and the resulting bubbles can be uniformly supplied.

In the embodiment described above, the supply pump 9a and the suction pump 9b create a difference in pressure between the outside and inside of the hollow fiber membranes 4. However, the present invention is not limited to this. For example, the technique in which a difference in pressure between the outside and inside of the hollow fiber membranes is created only by the supply pump, without the suction pump, is also within the intended scope of the present invention.

### INDUSTRIAL APPLICABILITY

As described above, the filtration device of the present invention can reduce adhesion of dirt to the surfaces of the hollow fiber membranes by supplying a bubble from the gas supply unit during external pressure filtration, and thus can maintain high filtration performance. Therefore, the filtration device can be suitably used in various areas.

### REFERENCE SIGNS LIST

1 filtration device
2 filtration module
3 gas supply unit
4 hollow fiber membrane
5 upper holding member
6, 16 lower holding member
6a outer frame
6b, 16b securing portion
7a, 17a, 27a inlet
7b, 17b, 27b outlet
7c, 17c, 27c gas discharge port
17d, 27d top surface portion
17e exhaust pipe
27e on-off valve

1. A filtration device comprising a tubular body having an inlet and an outlet for a solution to be treated, and a plurality of hollow fiber membranes aligned in the tubular body, wherein by creating a difference in pressure between the outside and inside of the hollow fiber membranes, water in the solution to be treated is passed from the outside to the inside;
the filtration device further includes a gas supply unit configured to supply a bubble from below the plurality of hollow fiber membranes; and
the tubular body has a gas discharge port above the inlet and the outlet, the gas discharge port being provided for discharging the bubble supplied from the gas supply unit to the outside.

2. The filtration device according to claim 1, wherein the filtration device is of an external pressure type.

3. The filtration device according to claim 1, wherein the gas discharge port is an opening at the top of the tubular body.

4. The filtration device according to claim 1, wherein the tubular body has an on-off valve for opening and closing the gas discharge port.

5. The filtration device according to claim 1, further comprising a filtration module including the plurality of hollow fiber membranes and a plurality of lower holding portions configured to hold lower parts of the hollow fiber membranes,
wherein the lower holding portions are arranged at intervals.

6. The filtration device according to claim 5, wherein the bubble supplied from the gas supply unit is divided into a plurality of bubbles after colliding with the filtration module.

7. A filtration method comprising using the filtration device according to claim 1 to filtrate a solution to be treated while causing the gas supply unit to supply a bubble.
